(19) United States
(12) Patent Application Publication
(10) Pub. No.: US 2020/0210979 A1
(43) Pub. Date: Jul. 2, 2020

(54) METHOD AND SYSTEM FOR PUBLIC TRANSPORTATION FARE CALCULATIONS BASED ON GEOLOCATION

(71) Applicant: MASTERCARD INTERNATIONAL INCORPORATED, Purchase, NY (US)

(72) Inventors: Chandan Garg, Patiala (IN); Meenakshi Shandilya, Bhopal (IN); Jaipal Singh Kumawat, Sikar (IN)

(73) Assignee: MASTERCARD INTERNATIONAL INCORPORATED, Purchase, NY (US)

(21) Appl. No.: 16/236,686

(22) Filed: Dec. 31, 2018

(51) Int. Cl. G06Q 20/14; G06Q 20/40

(52) U.S. Cl. CPC G06Q 20/145; G06Q 2220/00; G06Q 20/401

(57) ABSTRACT

A method for determining transportation fares includes: receiving a plurality of user data points for a user, wherein each user data point corresponds to a geographic location of a user including at least the geographic location and a timestamp; receiving a plurality of transport data points for each of a plurality of transportation vehicles, wherein each transport data point includes at least a geographic location of the respective transportation vehicle and a timestamp; identifying a specific transportation vehicle used by the user based on a correspondence between the geographic location and timestamp included in the plurality of user data points and the geographic location and timestamp included in the plurality of transport data points received for the specific transportation vehicle; determining a fare amount based on at least the identified specific transportation vehicle; and transmitting at least the determined fare amount.

### FIELD

The present disclosure relates to determining transportation fares on public transportation through geolocation, specifically the maintaining of geolocations of both public transportation vehicles and registered passengers to determine when a passenger is riding public transportation and their route to automatically determine fare.

### BACKGROUND

In many places, public transportation is indispensable for its passengers. Millions upon millions of people each day rely on public transportation as a means of getting around. Often, a person's livelihood may rely on their ability to utilize public transportation. As a result, passengers and public transportation operators alike are often interested in any technology that can be used to make their experiences more pleasant. One focus for entities has been the method for securing fares from their riders.

Traditionally, fares were paid in physical currency, through coins or notes. Over time, many systems migrated to the use of tokens, where a rider purchased tokens from an operator that were used in place of physical currency to pay a fare. As time has passed and technology has improved, many public transportation systems now utilize card-based systems. For such systems, a card is loaded with money through a magnetic stripe or other mechanism (e.g., integrated circuit chip) that is swiped or scanned to enter the public transportation system (e.g., via a turnstile on a bus, in a station, etc.). In some systems, riders are charged a flat fee as a fare each time they enter the system. In other systems, the system will charge the rider based on their entry and exit points, amount of time within the system, or other suitable criteria used to identify a variable fare amount.

Each system has their pros and cons. For flat fare systems, there is no disembark process and thus there can be faster throughput when riders leave the system, causing less delays and increasing rider efficiency. However, being unable to track when and where riders leave, and the paths of the riders, makes it difficult for the operator to determine metrics for their system, greatly increasing the difficulty in designing new routes, changing schedules, etc., and also makes it impossible for the operator to charge higher fares for longer trips. For variable fare systems, such metrics and longer fares are available to the operator, but having to have each passenger re-scan or re-swipe their card upon egress can cause slowdowns and delays, as well as being inconvenient for riders.

Thus, there is a need for a system that enables variable fares to be charged to riders and enable a system to track metrics of riders without requiring egress scans or swipes of the riders to reduce delays and increase rider convenience.

### SUMMARY

The present disclosure provides a description of systems and methods for determining transportation fares. A back end system is designed to capture geographic location (“geolocation”) information for both riders and passengers that are provided thereto, which is used to track the route of each vehicle in the transportation system. The geolocations are compared to determine if a passenger is currently on a vehicle, and, if so, can track their trip with the vehicle to determine the location and times of ingress and exit. This enables the system to determine fares for each passenger based on their route, mode, and precise trip, creating the capability of variable fares in the system without requiring the passenger to scan or swipe upon entry or exit to the system. The passengers can then be charged using any suitable method, providing for greater flexibility in payments for riders as well. In some embodiments, a blockchain may be used to store the geolocation data points, introducing a greater level of transparency in the system for auditing and third party analysis of the use of the transportation system resulting in greater advantages.

A method for determining transportation fares includes: receiving, by a receiver of a processing server, a plurality of user data points for a user, wherein each user data point corresponds to a geographic location of a user including at least the geographic location and a timestamp; receiving, by the receiver of the processing server, a plurality of transport data points for each of a plurality of transportation vehicles, wherein each transport data point includes at least a geographic location of the respective transportation vehicle and a timestamp; identifying, by a processing device of the processing server, a specific transportation vehicle used by the user based on a correspondence between the geographic location and timestamp included in the plurality of user data points and the geographic location and timestamp included in the plurality of transport data points received for the specific transportation vehicle; determining, by the processing device of the processing server, a fare amount based on at least the identified specific transportation vehicle; and transmitting, by a transmitter of the processing server, at least the determined fare amount.

A system for determining transportation fares includes: a receiver of a processing server configured to receive a plurality of user data points for a user, wherein each user data point corresponds to a geographic location of a user including at least the geographic location and a timestamp, and receive a plurality of transport data points for each of a plurality of transportation vehicles, wherein each transport data point includes at least a geographic location of the respective transportation vehicle and a timestamp; a processing device of the processing server configured to identify a specific transportation vehicle used by the user based on a correspondence between the geographic location and timestamp included in the plurality of user data points and the geographic location and timestamp included in the plurality of transport data points received for the specific transportation vehicle, and determine a fare amount based on at least the identified specific transportation vehicle; and a transmitter of the processing server configured to transmit at least the determined fare amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for determining transportation fares based on geolocation in accordance with exemplary embodiments.

FIG. 2 is a block diagram illustrating the processing server of the system of FIG. 1 for determining transportation fares based on geolocation in accordance with exemplary embodiments.

FIG. 3 is a flow diagram illustrating a process for determining transportation fares using geolocation and blockchain by the processing server of FIG. 2 in accordance with exemplary embodiments.

FIG. 4 is a flow chart illustrating an exemplary method for determining transportation fares in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Determining Transportation Fares

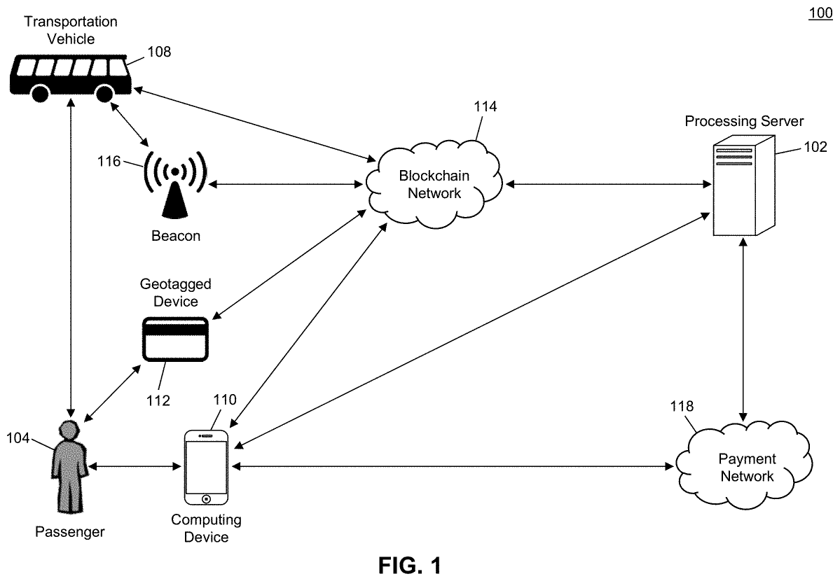

FIG. 1 illustrates a system 100 for the determination of variables fares in a public transportation system based on the geolocation of vehicles and riders inside the system, which, in some embodiments, may further utilize a blockchain for storage of geolocation data points therein.

The system 100 may include a processing server 102. The processing server 102, discussed in more detail below, may be configured to determine variable fares to be charged to passengers 104 in a public transportation system based on geolocations of the passengers 104 (e.g., as collected with passenger consent, such as through an opt-in system) as well as geolocations of transportation vehicles 108 that are in the public transportation system. In the system 100, a public transportation vehicle 108 may be fitted with a beacon 116 that is configured to identify its geolocation and transmit the geolocation to the processing server 102. The processing server 102 may record the geolocations of each transportation vehicle 108 in the public transportation system as provided by the corresponding beacons 116. Each beacon 116 may transmit its geolocation as well as a vehicle identifier, which may be a unique value associated with the transportation vehicle 108 for which it is associated. The processing server 102 may receive the geolocation and vehicle identifier and may store the data regarding the transportation vehicle's locations throughout its operating schedule. The geolocation may be in any type of format or representation that is suitable for performing the functions discussed herein. For instance, the geolocation may be a street address, latitude and longitude, or other suitable representation.

In the system 100, the geolocation of each passenger 104 in the public transportation system may also be tracked (e.g., while participating in use of the public transportation system). In some embodiments, the geolocation of a passenger 104 may be tracked through a computing device 110 in possession of the passenger 104. The computing device 110 may be any type of device configured to identify and report out its geographic location, such as a laptop computer, table computer, cellular phone, smart phone, smart watch, wearable computing device, implantable computing device, etc. The computing device 110 may identify its geolocation and may electronically transmit the geolocation to the processing server 102 via a suitable communication network and method. In one embodiment, the transmission may be direct to the processing server 102, such as through the Internet or a cellular communication network. In another embodiment, a mobile network operator associated with the computing device 110 may identify the geographic location of the computing device 110 and transmit the geographic location to the processing server 102 on behalf of the computing device 110.

In some embodiments, a passenger 104 may be issued a geotagged device 112, such as during a registration process or as a purchase that may be required to use the transportation vehicles 108 in the public transportation system. The geotagged device 112 may be any type of device whose geographic location can be identified and reported to the processing server 102, such as a smart card with a geographic location identification and transmitting capabilities. In some cases, both computing devices 110 and geotagged devices 112 may be used by passengers 104, such as depending on their personal preferences.

Each computing device 110 and geotagged device 112 may be configured to transmit its geographic location to the processing server 102 along with an identifier. The identifier may be a unique value that is unique to the passenger 104 associated therewith, or to the respective device. In some cases, a passenger 104 may have multiple identifiers associated therewith. For example, a passenger 104 may have multiple geotagged devices 112 (e.g., in case one is lost or left at home or office, they may use another as a backup) as well as a computing device 110 that may be used when riding. In such an instance, the processing server 102 may have the unique identifier of each associated with the passenger's account, to where the passenger 104 may be charged for fares determined for trips where any of the associated geotagged devices 112 or computing devices 110 was used.

The processing server 102 may accordingly receive the geolocation information for a passenger 104, which may include the geolocation and identifier for the passenger 104 throughout their journey. In some cases, each time a geolocation is reported, a timestamp may be included, such as for instances where transmission may be unavailable, such as due to a lack of signal, underground or tunnel travel, etc. In other cases, the processing server 102 may record a timestamp when a geolocation is received.

In some embodiments, the passenger 104 may select when geolocations are to be reported to the processing server 102. For example, the computing device 110 may include an application program thereon and executed thereby that is configured to report its geolocation to the processing server 102, where the passenger 104 may be able to provide an instruction to the application program as to when to start or stop reporting the geolocation. In another example, a geotagged device 112 may have a switch included therein that may be toggled by the passenger 104 to stop or start the geolocation reporting of the geotagged device 112. In yet another example, a geotagged device 112 may include a switch to turn on or off geolocation transmission, which may be triggered when the passenger 104 enters a transportation vehicle 108 or a station in the public transportation system. For instance, the passenger 104 may tap the geotagged device 112 to a near field communication pad that may trigger the reporting of geolocation, or the geotagged device 112 may receive a signal broadcast by a beacon 116 that starts the geolocation reporting. In some cases, the geolocation reporting may be stopped when receipt of the signal from the beacon 116 has ceased, the passenger 104 has selected to stop the reporting, another near field communication tap is made, or a predetermined period of time has passed. In some instances, the geolocation reporting may be stopped by the processing server 102 (or the processing server 102 may ignore future reports) if the passenger 104 is determined to have left the public transportation system, as discussed below.

Once geolocation information has been received for transportation vehicles 108 and passengers 104, the processing server 102 may be configured to determine fares to be charged to passengers 104. The processing server 102 may match a passenger 104 to a transportation vehicle 108 based on similarity in their geolocations and corresponding timestamps. For instance, if the passenger 104 is following the same path as a transportation vehicle 108 at the same time, the passenger 104 may be determined to be in the transportation vehicle 108. In cases where the starting of geolocation reporting is triggered, the computing device 110 or geotagged device 112 may report the transportation vehicle 108 being used, such as identified via the beacon 116 or input by the passenger 104. In some instances, the processing server 102 may confidence scores to determine how confident the system is in assigning the passenger 104 to a transportation vehicle 108 depending on, for example, how close the geographic locations and timestamps are, as well as how many matching geolocation-timestamp pairs have been found. In such instances, a fare may be not calculated for a passenger 104 until the confidence score matches a predetermined threshold.

In some instances, a transportation vehicle 108 may have four, or other suitable number, of beacons 116 installed therein, which may be used to define boundaries of the transportation vehicle 108. In such instances, the geolocations of the passenger 104 may be compared to the boundaries of the transportation vehicle 108 at each reporting interval to determine if the passenger 104 is on the transportation vehicle 108, as opposed to simply being nearby (e.g., in a car that is following a public transportation bus). Additional considerations may be utilized where suitable, such as checking for the passenger 104 waiting at a known bus stop, subway station, etc. prior to boarding a transportation vehicle 108.

Once the processing server 102 has determined that the passenger 104 was riding a transportation vehicle 108, the processing server 102 may calculate a fare for the passenger 104 for their trip. The fare may be based on at least the transportation vehicle 108 being ridden, as well as any other suitable criteria, such as a distance traveled, a time of transit, the entry or exit points of the transportation vehicle 108, entry or exit points in the public transportation system, number of transfers, time of day, day of week, etc. In some cases, the processing server 102 may be configured to calculate the fare with discounts being applicable thereto, such as based on the passenger's registration with the system, such as to provide for discounts for seniors, military, students, etc.

Once a fare has been calculated, the fare may be charged to the passenger 104. The fare may be charged using any suitable method. For instance, in one example, the passenger 104 may, when registering with the public transportation system, provide a payment method that may be automatically charged each time the passenger 104 uses the public transportation system. In another example, a passenger 104 may have a prepaid account that they may deposit money into, which may be deducted from when the public transportation system is used. In yet another example, a bill may be sent to the passenger 104 (e.g., via their registered computing device 110 or other suitable method) charging them for their fare, which may be sent after each fare occurs, at predetermined intervals (e.g., daily, weekly, monthly, etc.), or at predetermined amounts (e.g., each time aggregated fares total above $50). The passenger 104 may pay their fare(s) using any suitable method, such as via a payment network 118. For example, the passenger 104 may initiate a payment transaction with the payment network 118 through any suitable method, which may process the payment transaction through payment rails resulting in payment being made to the processing server 102. In one such case, the passenger 104 may provide their payment credentials to the processing server 102 (e.g., via the computing device 110), which may be submitted to the payment network 118 for the processing of a payment transaction funded by a transaction account associated with the payment credentials.

In some embodiments, the system 100 may utilize a blockchain for the storage of geolocation data and/or payment of fares. In such embodiments, each passenger 104 may have a blockchain wallet associated therewith. The blockchain wallet may be associated with a blockchain network 114 that is used to transmit and receive blockchain currency in electronic payment transactions conducted via the blockchain network 114. A blockchain wallet may be an application program that is executed by a computing device 110 or geotagged device 112 possessed by the passenger 104 that is configured for such usage. A blockchain wallet may include a private key of a cryptographic key pair that is used to generate digital signatures that serve as authorization by the passenger 104 for a blockchain transaction, where the digital signature can be verified by the blockchain network 114 using the public key of the cryptographic key pair. In some cases, the term “blockchain wallet” may refer specifically to the private key, which may be stored in a suitable memory or storage mechanism of the computing device 110 or geotagged device 112.

The blockchain network 114 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 may be a node in the blockchain network 114. In some such embodiments, each node in the blockchain network 114 may be configured to perform the functions of the processing server 102 as discussed herein. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 114 prior to the generation and addition of a new block to the blockchain in order for the change to be made permanent. Computational and communication limitations may make such a modification exceedingly difficult, if not impossible, thus rendering the blockchain immutable.

In instances where the blockchain may be used for payments, a blockchain data value may correspond to a blockchain transaction. A blockchain transaction may consist of at least: a digital signature of the sender of currency (e.g., the passenger 104) that is generated using the sender's private key, a blockchain address of the recipient of currency (e.g., the public transportation system) generated using the recipient's public key, and a blockchain currency amount that is transferred. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. In some cases, a blockchain transaction may also include the sender's public key, for use by any entity in validating the transaction. For the processing of a blockchain transaction, such data may be provided to a node in the blockchain network 114, either by the sender (e.g., via the computing device 110) or the recipient. The node may verify the digital signature and the sender's access to the funds, and then include the blockchain transaction in a new block. The new block may be validated by other nodes in the blockchain network 114 before being added to the blockchain and distributed to all of the nodes in the blockchain network 114.

In a standard blockchain transaction, the passenger 104 may thus generate a digital signature using the computing device 110 (e.g., or geotagged device 112, as applicable) using the private key thereof. The public transportation system (e.g., via the processing server 102) may generate a blockchain address using its public key, which may be provided to the computing device 110. In some cases, the public transportation system may provide the computing device 110 with its public key, where the computing device 110 may generate the blockchain address. The computing device 110 may then submit the required information to a node in the blockchain network 114 for processing. In some instances, the node may return a blockchain transaction identifier to the computing device 110, which may be a value that is unique to that blockchain transaction for identification thereof. In such traditional transactions, the public transportation system may be required to generate blockchain address or distribute its public key, and, in some cases, may be required to submit the transaction data directly to blockchain networks 114. In the system 100, the processing server 102 may perform these functions as part of the public transportation system. In some embodiments, the beacon 116 on the transportation vehicle 108 being used by the passenger 104 may perform the functions of the public transportation system as discussed herein.

In instances where the blockchain is used to store geolocation data information, each blockchain data value may be configured to store geolocation data. In some embodiments, the blockchain network 114 may operate separate blockchains for blockchain currency transactions and for the storage of geolocation data. In other embodiments, a single blockchain or a partitioned blockchain may be used, where the blockchain data values may have separate formatting or the formatting may be suitable for use of a blockchain data value for both transactions and geolocation data. Blockchain data values configured to store geolocation data may include the geolocation, timestamp, and identifier (e.g., transportation vehicle 108, passenger 104, computing device 110, geotagged device 112, beacon 116, etc.) for the identified geolocation. In some such embodiments, the device submitting the geolocation (e.g., computing device 110 or geotagged device 112 for the passenger 104) may generate a digital signature for the geolocation submitting using the private key of its blockchain wallet, which may be verified by a node in the blockchain network 114 using the corresponding public key for the geolocation to be determined to be genuine. In some instances, geolocations and/or identifiers may be hashed prior to storage in the blockchain, such as to prevent the personal identification of passengers 104 and to prevent the tracking of a passenger's real geographic location. In such instances, the processing server 102 may be aware of the hashing mechanism used to be able to determine the geographic location and/or identifier corresponding to a hashed value. In some such instances, encryption may be used instead of hashing, to enable the processing server 102 to perform decryption. In embodiments where a blockchain is used, the processing server 102 may identify geolocations in the blockchain and may use the geolocations from the blockchain in fare calculations.

The methods and systems discussed herein enable fares for public transportation to be determined for a passenger's exact trip, without needing the passenger 104 to scan or provide any indication that they are exiting the system, or, in some cases, even performing any actions when entering the system. Through the use of recording geolocations of both transportation vehicles 108 and passengers 104, trips taken by passengers 104 can be determined, and from there, fares to be paid. This enables a public transportation system to both charge variable fares and to have complete metrics regarding the use of the public transportation system by its passengers 104 as the precise trips of all passengers 104 can be determined. Thus, the methods and systems discussed herein improve on existing fare systems as they can calculate and charge variable fares while also tracking passenger movement.

### Processing Server

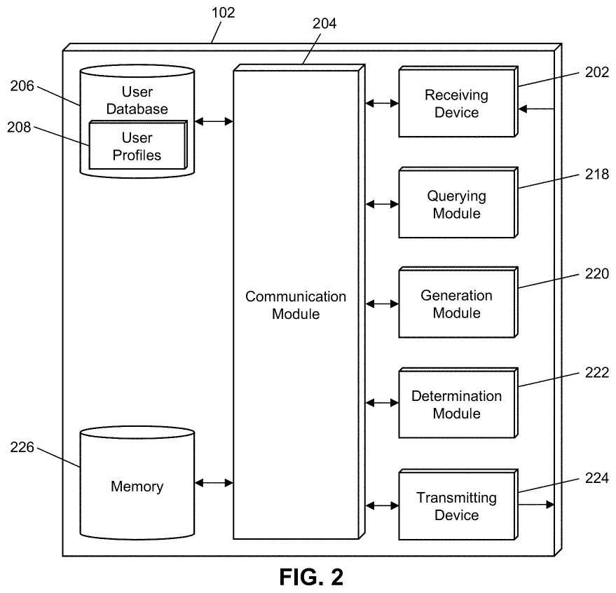

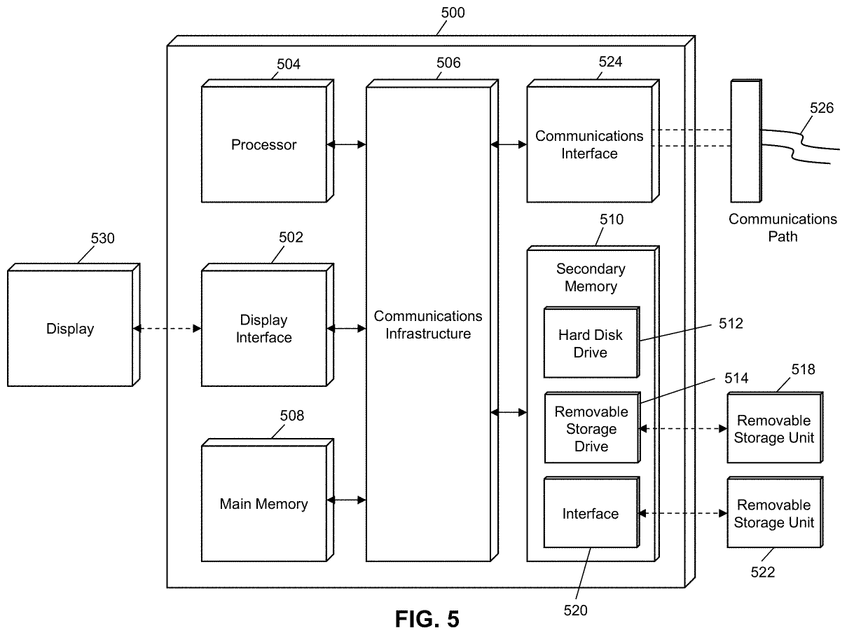

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from transportation vehicles 108, computing devices 110, geotagged devices 112, blockchain networks 114, beacons 116, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by transportation vehicles 108 and beacons 116 that are superimposed or otherwise encoded with geolocation data for a transportation vehicle 108, which may include at least a geolocation and a vehicle and/or beacon identifier, which may also include a timestamp. The receiving device 202 may also be configured to receive data signals electronically transmitted by computing devices 110 and geotagged devices 112 that are superimposed or otherwise encoded with geolocations and unique identifiers associated with a passenger 104 or the respective device, which, in some instances, may also be accompanied by a timestamp. The receiving device 202 may also be configured to receive data signals electronically transmitted by nodes in a blockchain network 114, which may be superimposed or otherwise encoded with blockchain data values, which, in instances where the processing server 102 may be a node in the blockchain network 114, may be included in new blocks for verification by the processing server 102.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, determination module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a user database 206. The user database 206 may be configured to store a plurality of user profiles 208 using a suitable data storage format and schema. The user database 206 may be a relational database that utilizes structured query language for the storage, identification, modifying, updating, accessing, etc. of structured data sets stored therein. Each user profile 208 may be a structured data set configured to store data related to a passenger 104 in the public transportation system. A user profile 208 may include a unique identifier associated with the user profile 208 and/or related passenger 104, such as may be used in geolocation data entries (e.g., stored in the blockchain), as well as the identifiers for any computing devices 110 or geotagged devices 112 registered to the related passenger 104. In some cases, the user profile 208 for a passenger 104 may be configured to store geolocation data entries for each geolocation reported to the processing server 102 via the associated computing devices 110 and geotagged devices 112. In some instances, a user profile 208 may be used to store calculated fares, such as for use in charging the passenger 104 at a predetermined interval or when the outstanding amount owed reaches a threshold value.

The processing server 102 may include a querying module 218. The querying module 218 may be configured to execute queries on databases to identify information. The querying module 218 may receive one or more data values or query strings, and may execute a query string based thereon on an indicated database, such as the user database 206, to identify information stored therein. The querying module 218 may then output the identified information to an appropriate engine or module of the processing server 102 as necessary. The querying module 218 may, for example, execute a query on the user database 206 to identify a unique identifier associated with a passenger 104 based on the identifier of a geotagged device 112 used to report a geolocation, for use of the unique identifier in storing the geolocation data in a blockchain.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to computing devices 110, such as prompts for digital signatures, registration data, payment credentials, registration of new computing devices 110 or geotagged devices 112, etc., as well as for transmission to nodes in the blockchain network 114, such as for a new blockchain transactions to be processed or blockchain data values to be entered into the blockchain. The generation module 220 may also be configured to generate blockchain addresses, such as in instances where the processing server 102 possess a public key for the public transportation system in embodiments where fares may be paid via a blockchain currency.

The processing server 102 may also include a determination module 222. The determination module 222 may be configured to make determinations for the processing server 102 as part of the functions discussed herein. The determination module 222 may receive an instruction as input, may make a determination based on the instruction, and may output a result of the determination to another module or engine of the processing server 102. In some cases, the determination module 222 may receive data to be used for the determination with the input. In some instances, the determination module 222 may be configured to identify data for use in making the determination, such as by instructing the querying module 218 to execute a query to identify such data. The determination module 222 may be configured to, for example, determine what transportation vehicle 108 a passenger 104 used and for what duration and/or stops based on a comparison of geolocation data for the transportation vehicle 108 and passenger 104. The determination module 222 may also be configured to determine a fare amount due by a passenger 104 for a trip based on their geolocation data and rate information for the transportation vehicle 108 used for the trip.

The processing server 102 may also include a transmitting device 224. The transmitting device 224 may be configured to transmit data over one or more networks via one or more network protocols. In some instances, the transmitting device 224 may be configured to transmit data to transportation vehicles 108, computing devices 110, geotagged devices 112, blockchain networks 114, beacons 116, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to transportation vehicles 108 and beacons 116 that are superimposed or otherwise encoded with data requests for geolocations of the transportation vehicle 108. The transmitting device 224 may also be configured to electronically transmit data signals to computing devices 110 and/or geotagged devices 112, which may be superimposed or otherwise encoded with requests for geolocation data or bills or other fare information based on rides taken by the related passenger 104. The transmitting device 224 may also be configured to electronically transmit data signals to nodes in a blockchain network 114, which may be superimposed with geolocation information for new blockchain data values or requests for blockchain data values for use in identifying trips by passengers 104 and calculating fares.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, hashing algorithms for generating blocks, credentials for validation, usage rule templates, communication data for blockchain nodes, communication data for computing devices 110, geotagged devices 112, transportation vehicles 108, and beacons 116, routing information for transaction messages, rate schedules, fare calculation algorithms, transportation timetables and routes, geolocation data, public keys, etc.

### Process for Charging Transportation Fares Using Geolocation

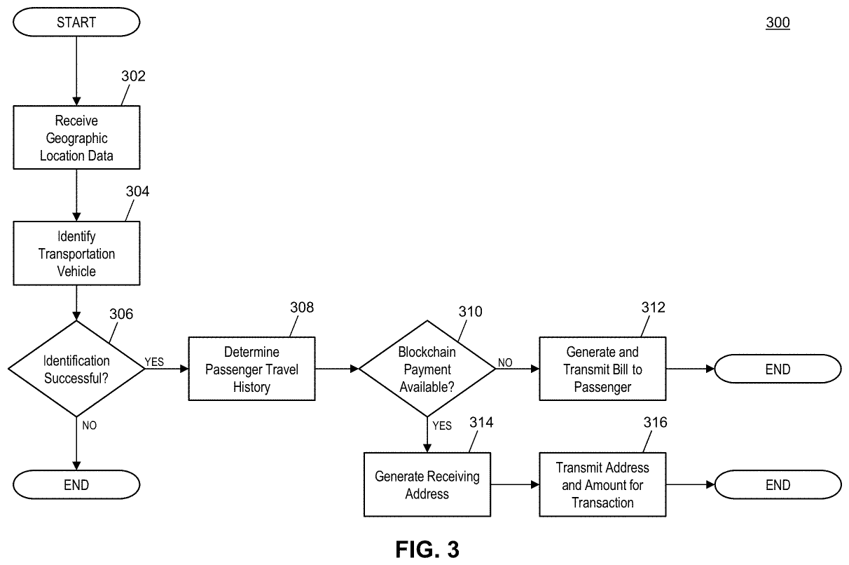

FIG. 3 illustrates an example process 300 for the determination and charging of fares for the use of public transportation based on captured geolocation data as performed by the processing server 102 of FIG. 2, such as for use in the system 100 of FIG. 1.

In step 302, the receiving device 202 of the processing server 102 may receive geolocation data for a passenger 104, such as may be transmitted by a computing device 110 or geotagged device 112 in possession of the passenger 104. The geolocation data may include a geographic location, timestamp for when the geolocation was identified, and an identifier. In some cases, the identifier may be a unique identifier for the passenger 104. In other cases, the identifier may be an identifier unique to the computing device 110 or geotagged device 112, which may be used (e.g., via a query by the querying module 218 executed on the user database 206) to identify the unique identifier for a passenger 104 associated therewith in the passenger's user profile 208.

In step 304, the determination module 222 of the processing server 102 may attempt to identify a transportation vehicle 108 on which the passenger 104 is riding. To attempt the identification, the determination module 222 may compare the geolocation and time of the passenger 104 with the geolocation and time of each transportation vehicle 108 in the public transportation system to check for a match indicating that the passenger 104 is on a transportation vehicle 108. In step 306, the processing server 102 may review the determination of the determination module 222 to check if a transportation vehicle 108 was successfully identified. If no such identification occurred (e.g., the passenger 104 was not determined to be currently on a transportation vehicle 108), then the process may complete as there is no trip being undertaken by the passenger 104 and therefore no fare to be paid.

If the processing server 102 determines that the passenger 104 was on a transportation vehicle 108 in the public transportation system, then, in step 308, the determination module 222 of the processing server 102 may determine the travel history for the passenger 104 (e.g., collected with the explicit consent of the passenger 104). The travel history may be determined by going back through the previous or future geolocations of the passenger 104 when compared to the transportation vehicle 108 on which the passenger 104 was identified to have been traveling until the paths diverge, indicating the points of ingress and egress by the passenger 104. Once the ingress and egress points are identified, the entire trip taken by the passenger 104 may be identified through their geolocations and the geolocations of the transportation vehicle 108. The determination module 222 of the processing server 102 may determine the fare to be paid by the passenger 104 based on their identified trip, and fare information for the transportation vehicle 108.

In step 310, the processing server 102 may determine if blockchain is a viable payment method for the passenger 104 for the fare for their trip. If blockchain is not available, then, in step 312, the generation module 220 of the processing server 102 may generate a bill, invoice, or other request for payment of the fare amount, which may be transmitted, by the transmitting device 224 of the processing server 102, to the computing device 110 associated with the passenger 104 or via any other suitable communication method. If blockchain is available for payment, then, in step 314, the generation module 220 may generate a receiving blockchain address for the public transportation system using a public key associated therewith (e.g., stored in the memory 226 of the processing server 102). In step 316, the transmitting device 224 may electronically transmit the fare amount and receiving blockchain address to the passenger's computing device 110, or via any other suitable method, such that the passenger 104 can initiate a blockchain transaction for payment of the fare amount (e.g., or an equivalent amount in blockchain currency thereto, as applicable) to the public transportation system.

### Exemplary Method for Determining Transportation Fares

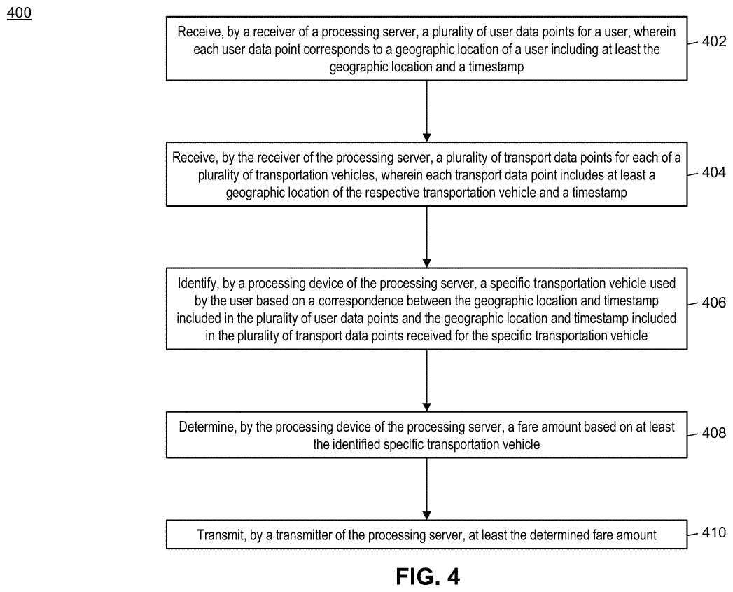

FIG. 4 illustrates a method 400 for the determining of fares for the use of public transportation through the use of geolocations identified for a passenger as well as a transportation vehicle used in the public transportation system.

In step 402, a plurality of user data points may be received by a receiver (e.g., the receiving device 202) for a user (e.g., the passenger 104), wherein each user data point corresponds to a geographic location of a user including at least the geographic location and a timestamp. In step 404, a plurality of transport data points may be received by the receiver of the processing server for each of a plurality of transportation vehicles (e.g., transportation vehicles 108), wherein each transport data point includes at least a geographic location of the respective transportation vehicle and a timestamp.

In step 406, a specific transportation vehicle used by the user may be identified by a processing device (e.g., the determination module 222) of the processing server based on a correspondence between the geographic location and timestamp included in the plurality of user data points and the geographic location and timestamp included in the plurality of transport data points received for the specific transportation vehicle. In step 408, a fare amount may be determined by the processing device of the processing server based on at least the identified specific transportation vehicle. In step 410, at least the determined fare amount may be transmitted by a transmitter (e.g., the transmitting device 224) of the processing server.

In one embodiment, the determined fare amount may be transmitted to a node in a blockchain network (e.g., the blockchain network 114). In a further embodiment, the method 400 may further include generating, by the processing device of the processing server, a blockchain address using a public key of a cryptographic key pair, wherein the blockchain address is transmitted with the determined fare amount. In some embodiments, the determine fare amount may be transmitted to a computing device (e.g., the computing device 110) associated with the user.

In one embodiment, each user data point may be stored in a blockchain data value stored in a blockchain. In some embodiments, a user data point of the plurality of user data points may have been received at a periodic interval between a start time and an end time. In one embodiment, the fare amount may be further based on the timestamp included in each of the plurality of user data points. In some embodiments, the fare amount may be further based on one or more fare calculation rules.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for determining transportation fares. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining transportation fares, comprising:
receiving, by a receiver of a processing server, a plurality of user data points for a user, wherein each user data point corresponds to a geographic location of a user including at least the geographic location and a timestamp;
receiving, by the receiver of the processing server, a plurality of transport data points for each of a plurality of transportation vehicles, wherein each transport data point includes at least a geographic location of the respective transportation vehicle and a timestamp;
identifying, by a processing device of the processing server, a specific transportation vehicle used by the user based on a correspondence between the geographic location and timestamp included in the plurality of user data points and the geographic location and timestamp included in the plurality of transport data points received for the specific transportation vehicle;
determining, by the processing device of the processing server, a fare amount based on at least the identified specific transportation vehicle; and
transmitting, by a transmitter of the processing server, at least the determined fare amount.

2. The method of claim 1, wherein the determined fare amount is transmitted to a node in a blockchain network.

3. The method of claim 2, further comprising:
generating, by the processing device of the processing server, a blockchain address using a public key of a cryptographic key pair, wherein
the blockchain address is transmitted with the determined fare amount.

4. The method of claim 1, wherein the determined fare amount is transmitted to a computing device associated with the user.

5. The method of claim 1, wherein each user data point is stored in a blockchain data value stored in a blockchain.

6. The method of claim 1, wherein a user data point of the plurality of user data points has been received at a periodic interval between a start time and an end time.

7. The method of claim 1, wherein the fare amount is further based on the timestamp included in each of the plurality of user data points.

8. The method of claim 1, wherein the fare amount is further based on one or more fare calculation rules.

9. A system for determining transportation fares, comprising:
a receiver of a processing server configured to
receive a plurality of user data points for a user, wherein each user data point corresponds to a geographic location of a user including at least the geographic location and a timestamp, and
receive a plurality of transport data points for each of a plurality of transportation vehicles, wherein each transport data point includes at least a geographic location of the respective transportation vehicle and a timestamp;
a processing device of the processing server configured to
identify a specific transportation vehicle used by the user based on a correspondence between the geographic location and timestamp included in the plurality of user data points and the geographic location and timestamp included in the plurality of transport data points received for the specific transportation vehicle, and
determine a fare amount based on at least the identified specific transportation vehicle; and
a transmitter of the processing server configured to transmit at least the determined fare amount.

10. The system of claim 9, wherein the determined fare amount is transmitted to a node in a blockchain network.

11. The system of claim 10, wherein
the processing device of the processing server is further configured to generate a blockchain address using a public key of a cryptographic key pair, and
the blockchain address is transmitted with the determined fare amount.

12. The system of claim 9, wherein the determined fare amount is transmitted to a computing device associated with the user.

13. The system of claim 9, wherein each user data point is stored in a blockchain data value stored in a blockchain.

14. The system of claim 9, wherein a user data point of the plurality of user data points has been received at a periodic interval between a start time and an end time.

15. The system of claim 9, wherein the fare amount is further based on the timestamp included in each of the plurality of user data points.

16. The system of claim 9, wherein the fare amount is further based on one or more fare calculation rules.
